(19) United States
(12) Patent Application Publication
(10) Pub. No.: US 2005/0201308 A1
(43) Pub. Date: Sep. 15, 2005

(54) Wireless communication system and wireless communication method

(75) Inventors: Masahiro Sekiya, Tokyo (JP); Akira Yamaga, Kanagawa (JP); Kiyoshi Toshimitsu, Kanagawa (JP); Tetsu Nakajima, Kanagawa (JP); Daisuke Taki, Kanagawa (JP); Yukimasa Miyamoto, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/065,045

(22) Filed: Feb. 25, 2005

(30) Foreign Application Priority Data
Feb. 27, 2004 (JP) 2004-053031

(51) Int. Cl. H04B 7/00

(52) U.S. Cl. 370/310

(57) ABSTRACT

A wireless communication system includes a first communication apparatus, a second communication apparatus, and a third communication apparatus which are mutually communicable by wireless. The second communication apparatus includes a receiving section for receiving a signal and a transmission section. The transmission section transmits a first transmission signal whose destination is the third communication apparatus with power enough to reach both the first communication apparatus and the third communication apparatus, and transmits a second transmission signal whose destination is the third communication apparatus in accordance with a response signal from the third communication apparatus including an information related to received power or receipt quality of the first transmission signal in the third communication apparatus with power enough to reach the third communication apparatus.

### CROSS-REFERENCE TO RELATED APPLICATIONS

This application is based upon and claims the benefit of priority from the prior Japanese Patent Applications No. 2004-053031, filed on Feb. 27, 2004, the entire contents of which are incorporated herein by reference.

### BACKGROUND OF THE INVENTION

1. Field of the Invention

The present invention relates to a wireless communication system and a wireless communication method.

2. Description of the Related Art

In a wireless LAN system conforming to IEEE 802.11 standard, a plurality of wireless terminals is often connected to one wireless base station in a communicable manner. A unit constituted of a wireless base station and wireless terminals connected in a wirelessly communicable manner to the wireless base station is called a BSS (Basic Service Set).

According to IEEE 802.11 standard, a plurality of wireless terminals included in a certain BSS can communicate with each other through a wireless base station (hereinafter, referred to as “indirect communication”). In addition, the plurality of wireless terminals can perform direct communication with each other while bypassing the wireless base station (hereinafter, referred to as “direct communication”) (see, e.g., JP-A-2003-174452).

(Case 1) In a case where wireless terminals perform direct communication, first, a source terminal transmits a request for direct communication (hereinafter called a “direct communication request”) to a destination terminal through a wireless base station. Next, the destination terminal transmits, to the source terminal, a response to direct communication through the wireless base station. Upon recognition of the direct communication and the response to direct communication, the wireless base station provides the source terminal and the destination terminal with priority time. The wireless base station transmits, to the source terminal, a frame permitting start of direct communication (hereinafter, referred to as “permission frame”). As a result, the source terminal can start direct communication with the destination terminal. The “priority time” means a time during which the wireless base station and the wireless terminals other than those provided with the priority time are storing signals to be transmitted to the wireless terminals performing the direct communication without transmitting the signals thereto. Immediately after the priority time, that is, after completion of the direct communication, the wireless base station transmits the thus-stored signals to the wireless terminals.

(Case 2) IEEE 802.11 standard also describes a request for transmission suppression (hereinafter simply called a “transmission suppression request”). The transmission suppression request is a signal which causes the wireless terminals other than the destination terminal or wireless base stations other than the destination wireless base station in the BSS to suppress transmission for a predetermined period. For instance, a wireless base station transmits a transmission suppression request toward other wireless terminals before performing communication with the destination terminal. Wireless terminals—other than the destination terminal—which have received the transmission suppression request holds transmission of data for a predetermined period. As a result, the wireless base station and the destination terminal can communicate with each other without being disturbed by other wireless terminals. JP-A-2003-174452 is referred to as a related art.

In Case 1, after transmitting the permission frame, the wireless base station monitors whether or not the source terminal has actually transmitted the data to the destination terminal. As a result, the wireless base station can provide the priority time to other wireless terminals in a case where the wireless terminals are not performing direct communication.

A signal which is monitored by the wireless base station is usually only the first data immediately after when the wireless base station provides the source wireless terminal with the permission frame. Specifically, the wireless base station provides the wireless terminals with a predetermined priority time from a time point when the wireless base station has checked the first data, and does not perform monitoring within the priority time. Therefore, the first data transmitted to the destination terminal after commencement of the direct communication must reach the wireless base station as well as the destination terminal. Meanwhile, data subsequent to the first data are required to reach only the destination terminal, and not required to reach the wireless base station.

However, in a related art, since the source terminal and the destination terminal have not controlled transmission power, power by the respective wireless terminals in direct communication is excessively consumed. In addition, when the wireless terminals continue transmission with a greater electric power value than necessary, interference may possibly be caused to other wireless terminals irrelevant to the direct communication; and furthermore, may result in leakage of information.

In Case 2, transmission suppression request transmitted first must reach not only the destination terminal but also other wireless terminals. Accordingly, the wireless base station or the wireless terminal which transmits a transmission suppression request must transmit the transmission suppression request with comparatively great power enough to reach the destination terminal or other wireless terminals. Subsequently, however, the wireless base station or the wireless terminal is enough so long as transmitting the signal with power comparatively small but enough to reach only the destination terminal.

Therefore, when the transmission power is set such that the transmission signal reaches the destination terminal and other wireless terminals, power by the wireless base station or the wireless terminals is excessively consumed as well as Case 1. In addition, when the wireless base station or the wireless terminals continue transmission with a greater electric power value than necessary, as is in Case 1, interference may possibly be caused to other wireless terminals irrelevant to the direct communication; and furthermore, may result in leakage of information.

### SUMMARY OF THE INVENTION

The object of the invention is to provide a wireless communication system and a wireless communication method which enable to provide adequate security for communication between wireless communication apparatuses.

According to an aspect of the present invention, a wireless communication system includes a first communication apparatus, a second communication apparatus, and a third communication apparatus which are mutually communicable by wireless.

The first communication apparatus includes a first transmission section which receives a signal, and a first transmission section which transmits a first transmission signal whose destination is the second communication apparatus to both the second communication apparatus and the third communication apparatus, and which transmits, to the second communication apparatus, a second transmission signal whose destination is the second communication apparatus with power enough to reach the second communication apparatus based on a response signal, which includes an information related to received power or receipt quality of the first transmission signal in the second communication apparatus, from the second communication apparatus.

The second communication section includes a second receiving section which receives the first transmission signal, a measurement section which measures received power or receipt quality of the first transmission signal, and a second transmission section which transmits the response signal to the first communication apparatus in accordance with the first transmission signal.

The third communication apparatus includes a third receiving device which receives the first transmission signal, and a third transmission section which stops transmission of signals to the first communication apparatus and the second communication apparatus for a predetermined period after receipt of the first transmission signal.

The invention also provides a wireless communication method with use of a wireless communication system including a first communication apparatus, a second communication apparatus, and a third communication apparatus which are mutually communicable by wireless.

The method comprises a step in which the first communication apparatus transmits a first transmission signal whose destination is the second communication apparatus with power enough to reach both the second communication apparatus and the third communication apparatus, a step in which the second communication apparatus receives the first transmission signal, and measures received power or receipt quality of the first transmission signal, a step in which the second communication apparatus transmits a response signal in response to the first transmission signal to the first communication apparatus, and a step in which the third communication apparatus stops transmission of signals to the first communication apparatus and the second communication apparatus during a predetermined period after receipt of the first transmission signal or the response signal.

According to the wireless communication system and the wireless communication method, excess transmission power is reduced, and the signals causing interference or leakage do not affect the wireless base stations other than the destination base station or wireless terminals other than the destination terminal.

### BRIEF DESCRIPTION OF THE DRAWINGS

FIG. 1 is a view showing a configuration of a wireless LAN system 100 according to a first embodiment of the present invention;

FIG. 2 is a block diagram showing a configuration of a wireless terminal 102;

FIG. 3 is a view showing a format of a MAC frame conforming to IEEE 802.11;

FIG. 4 is a flowchart showing operations of the wireless communication system 100;

FIG. 5 is a view showing operation timings of the first embodiment and transmission power of the wireless base station 101, and the wireless terminals 102, 103 respectively;

FIG. 6 is a flowchart showing operations of a wireless communication system of a third embodiment;

FIG. 7 is a view showing operation timings of the third embodiment and transmission power of the wireless base station 101, and the wireless terminals 102, 103, and 104 respectively; and

FIG. 8 is a view showing a configuration of a wireless LAN system constituted of a plurality of BSSS.

### DETAILED DESCRIPTION OF THE PREFERRED EMBODIMENTS

Embodiments according to the present invention will now be described in detail by reference to the drawings. The invention is not limited to the embodiments.

In the wireless communication system according to the embodiments, a source terminal or a source base station reduces transmission power to a degree at which signals can reach a destination terminal or a destination base station after establishment of communication with the destination terminal or the destination base station. As a result, the source terminal or the source base station can reduce excess transmission power.

### First Embodiment

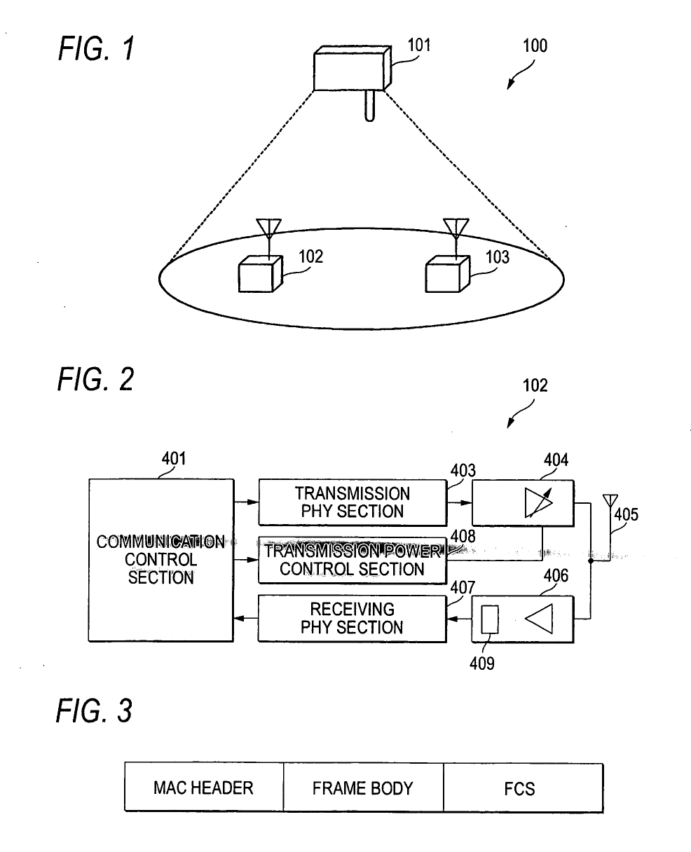

FIG. 1 is a view showing a configuration of a wireless LAN system 100 according to a first embodiment of the present invention. For the sake of clarity, the wireless LAN system 100 is constituted of a BSS including a single wireless base station 101, and two wireless terminals 102, 103. Three or more wireless terminals may be included.

The wireless base station 101 can communicate with the respective wireless terminals 102, 103 in accordance with IEEE 802.11. IEEE 802.11 may be any one of IEEE 802.11a, IEEE 802.11b, and IEEE 802.11g.

The wireless LAN system 100 also conforms to IEEE 802.11e. Therefore, the wireless terminals 102 and 103 can perform wireless communication (indirect communication) through the wireless base station 101, and perform wireless communication (direct communication) while bypassing the wireless base station 101.

FIG. 2 is a block diagram showing a configuration of a wireless terminal 102. The wireless terminal 102 comprises a communication control section 401, a transmission PHY (physical layer) section 403, a wireless transmission section 404, an antenna 405, a wireless receiving section 406, a receiving PHY section 407, and a transmission power control section 408.

The wireless receiving section 406 subjects a radio frequency of a receiving signal received by the antenna 405 to down-conversion, and outputs the signal to the receiving PHY section 407. The wireless receiving section 406 includes a measurement section 409 for measuring received power or receipt quality of the received signal. The measurement section 409 outputs a value of the received power or the receipt quality. The transmission PHY section 407 processes demodulation of the received signal of the radio frequency, and outputs to the communication control section 401.

The communication control section 401 performs transmission control of data, and executes processing of data link connection establishment, data transfer, and data link connection release. The communication control section 401 also generates a MAC frame of a transmission signal, determines a method for transmitting the MAC frame to the air (medium), and recognizes the type of a received MAC frame. The communication control section 401 also determines received power and receipt quality on the basis of a measurement result of the measurement section 409, thereby controlling the transmission power control section 408 on the basis of the result of determination. For instance, the communication control section 401 may have a reference value for received power of a received signal, thereby calculating a difference value between the received power and the reference value.

Meanwhile, the transmission PHY section 403 processes digital modulation of a transmission signal so that the transmission signal can be transmitted by wireless. The wireless transmission section 404 converts a transmission signal output from the transmission PHY section 403 into a radio frequency. The wireless transmission section 404 includes a variable amplifier which is capable of adjusting electric power amplification factor of the transmission signal, and amplifies electric power of the transmission signal and outputs the transmission signal to the antenna 405. The transmission power control section 408 controls the variable amplifier of the wireless transmission section 404 such that the transmission power value is increased or reduced on the basis of the received power, receipt quality of the MAC frame of the received signal, or calculation results thereof. The wireless terminal 103 and the wireless base station 101 have analogous configurations to that of the wireless terminal 102, and their repeated descriptions are omitted.

FIG. 3 is a view showing a format of a MAC (medium access control) frame conforming to IEEE 802.11. The MAC frame is constituted of a MAC header, a frame body, and an FCS (frame check sequence). The MAC header contains data identification information required for receiving processing of a frame. The frame body contains information corresponding to a frame type. The FCS is used for determination whether or not the MAC header and the frame body have been accurately received, and constituted of a CRC (cyclic redundancy code).

The MAC header further includes a frame control field for indicating the type of the frame, or the like; a valid duration field showing a period NAV (network allocation vector) during which transmission of other wireless terminals is inhibited by means of effecting virtual carrier sensing; and an address field for indicating a MAC address of a destination, a MAC address of a final destination, and a MAC address of a sender, etc.

MAC frames used for starting direct communication in accordance with IEEE 802.11 can be classified into three MAC frames: a data frame, a management frame, and a control frame. The classification is identified by the MAC header. A direct communication request and a response to direct communication may be either a management frame or a data frame.

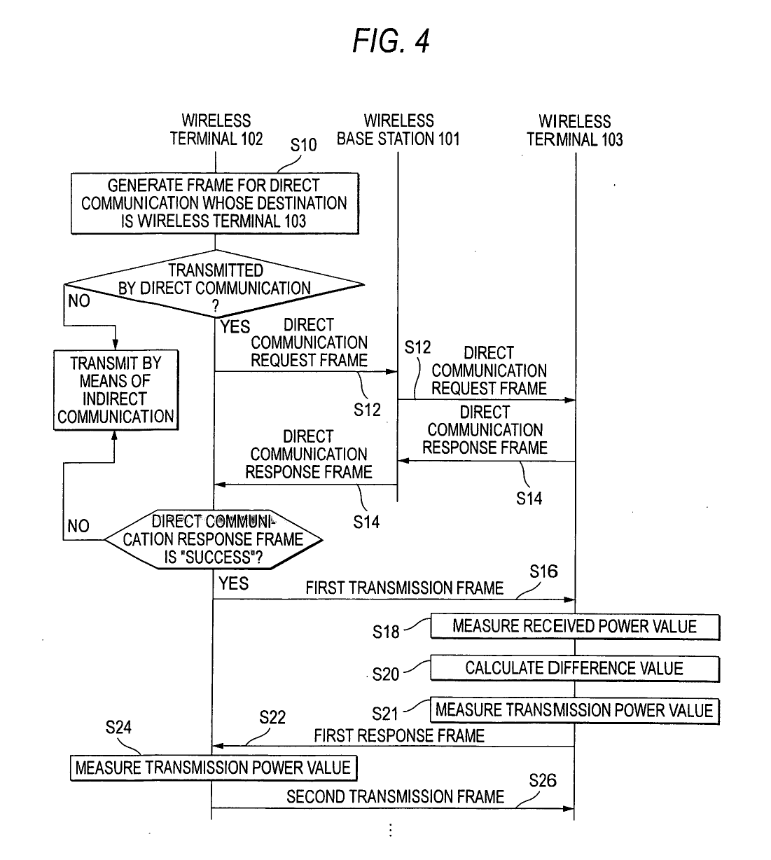

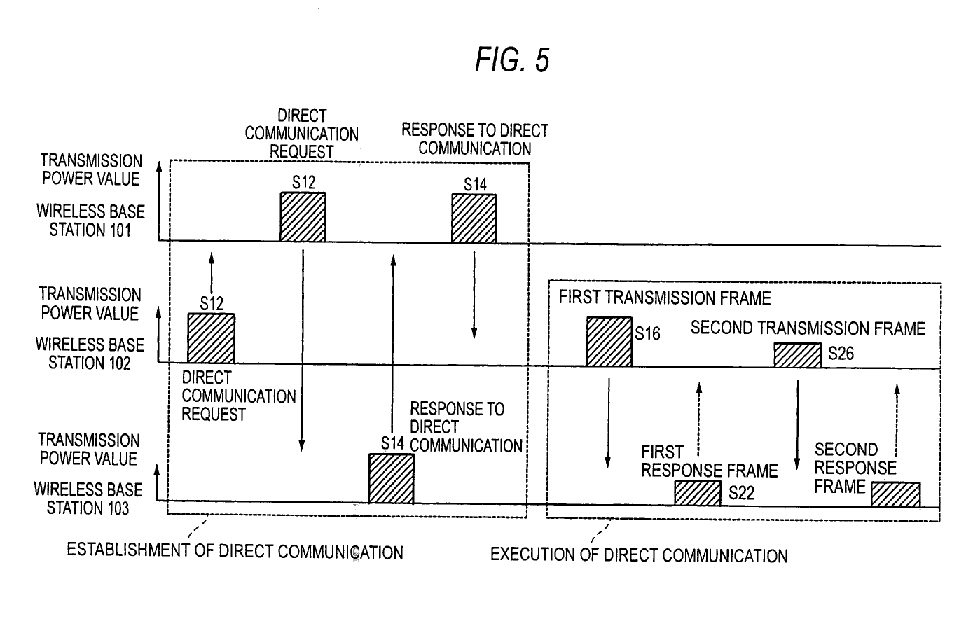

FIG. 4 is a flowchart showing operations of the wireless communication system 100. FIG. 5 is a view showing operation timings of the first embodiment and transmission power of the wireless base station 101, and those of the wireless terminals 102, 103 respectively. The wireless terminal 102 generates a frame whose destination is the wireless terminal 103 (S10). When the frame is transmitted to the wireless terminal 103 by direct communication, the wireless terminal 102 first transmits, to the wireless terminal 103, a direct communication request frame through the wireless base station 101 (S12). The direct communication request frame follows, for instance, a DLP (direct link protocol).

The wireless terminal 103 receives the direct communication request frame, and transmits a direct communication response frame through the wireless base station 101 (S14). The direct communication response frame follows, for instance, a DLP (direct link protocol). When the direct communication response frame is SUCCESS, the frame signifies that the wireless terminal 103 has accepted the direct communication. Accordingly, the wireless terminals 102 and 103 can perform direct communication while bypassing the wireless base station 101.

Direct communication is usually performed in a case where the wireless terminals 102 and 103 can communicate with each other with comparatively lower transmission power than that consumed in indirect communication through the wireless base station 101. Therefore, when the wireless terminals 102 and 103 perform indirect communication, comparatively high transmission power is required since the wireless terminals 102 and 103 must perform communication through the wireless base station 101. That is, during steps S12 through S14 before establishment of the direct communication, as shown in FIG. 5, both the wireless terminals 102 and 103 transmit transmission signals with transmission power values comparatively great enough to reach the wireless base station 101.

After the direct communication is established, the wireless terminal 102 transmits a first transmission frame directly to the wireless terminal 103. The wireless transmission section 404 transmits the first transmission frame of immediately after start of the direct communication with comparatively great transmission power so as to reach not only the wireless terminal 103 but also to the wireless base station 101 (S16). As shown in FIG. 5, the transmission power required this time is of the order of the transmission power required in step S12 through S14. By virtue of this, the wireless base station 101 can monitor whether or not the priority time is actually used by the wireless terminal 102 and 103. Upon receipt of the first transmission frame, the wireless base station 101 stores signals from other wireless terminals whose destinations are the wireless terminals 102, 103 during the priority time, and waits transmission of the signals.

Next, the wireless terminal 103 receives the first transmission frame, and the measurement section 409 of the wireless terminal 103 measures the received power of the first transmission frame (S18). The communication control section 401 of the wireless terminal 103 calculates a difference value between a reference value for received power which has been set in advance and the received power of the first transmission frame (S20). The reference value is set to a received power value of a signal which can be received by the wireless terminal 103, or a received power value with which a certain receipt quality can be kept. Subsequently, the wireless terminal 103 transmits a frame containing data on the difference value to the wireless terminal 102 as a response frame against the first transmission frame (S22). At this time, the only requirement for the wireless terminal 103 is to transmit the response frame with transmission power enough to reach the wireless terminal 102 on the basis of the difference value as shown in FIG. 5. For instance, when the difference value is greater than or equal to a predetermined threshold value, the transmission power is determined to have a margin. In this case, the transmission power control section 408 controls the wireless transmission section 404 so as to lower the transmission power value. In contrast, when the difference value is smaller than the threshold value, the communication control section 401 of the wireless terminal 102 determines that the transmission power has no margin. In this case, the transmission power control section 408 controls the wireless transmission section 404 such that the transmission power value is increased or constant (S21).

The wireless terminal 102 receives the response frame, and obtains data on the difference value (S24). When the difference value is greater than or equal to the threshold value, the communication control section 401 of the wireless terminal 102 determines that the transmission power has a margin. In this case, the transmission power control section 408 controls the wireless transmission section 404 so as to lower the transmission power value. In contrast, when the difference value is smaller than the threshold value, the communication control 401 determines that the transmission power has no margin. In this case, the transmission power control section 408 controls the wireless transmission section 404 such that the transmission power value is increased or constant (S24).

As a result, the wireless terminals 102, 103 can transmit a second transmission frame and transmission frames subsequent thereto or response frames corresponding thereto with appropriate electric power values (S26). Communication of the data pertaining to the electric power values of these signals may be effected in compliance with IEEE 802.11h.

According to the embodiment, the wireless terminal 102 transmits, in direct communication, the first transmission frame at such comparatively high power that the frame sufficiently reaches the wireless terminal 101 as shown in FIG. 5. Accordingly, the wireless base station 101 can allocate a priority time to the wireless terminals 102 and 103 without fail. Meanwhile, the wireless terminals 102 and 103 transmit the first transmission frame and transmission frames subsequent thereto at such comparatively low power that the frames sufficiently reach the wireless terminals 103 and 102, respectively. Accordingly, the wireless terminals 102 and 103 can reduce excessive power consumption. In addition, the wireless terminals 102 and 103 can increase transmission power when the transmission power is too low. Consequently, the wireless terminals 102 and 103 can transmit signals with appropriate transmission power.

Meanwhile, when the first frame from the wireless terminal 102 has failed to reach the wireless base station 101, the wireless base station 101 determines that the wireless terminals 102 and 103 are not performing direct communication, and cancels the priority time. Therefore, the first frame after establishment of the direct communication must reach not only the destination terminal but also the wireless base station 101 which has permitted the direct communication. According to the embodiment, since the first frame reaches not only the wireless terminal 103 but also the wireless base station 101, the priority time is not cancelled. Therefore, the wireless terminals 102 and 103 can continue direct communication.

### Second Embodiment

In the first embodiment, the wireless terminal 103 includes the difference value between the reference value for received power and the received power of the first transmission frame into the response frame. However, in a second embodiment, the wireless terminal 103 merely transmits, to the wireless terminal 102, a transmission-power-instruction signal—which instructs to increase or reduce transmission power—as a response frame. Configurations of the embodiment is analogous to those of the first embodiment, and their repeated descriptions are omitted.

Operations of the embodiment during steps S10 through S16 shown in FIG. 4 are the same as those of the first embodiment. Next, in step S18, the measurement section 409 of the wireless terminal 103 measures received power or receipt quality. The “receipt quality” means, for instance, a frame error rate, a packet error rate, or a bit error rate. Next, in step S20, the communication control section 401 compares received power or receipt quality with a threshold value which has been set in advance. Subsequently, in step S22, when the received power or the receipt quality is greater than or equal to the threshold value, the wireless terminal 103 transmits a transmission-power-instruction signal which reduces the transmission power, or the same which maintains the transmission power constant to the wireless terminal 102. When the received power or the receipt quality is smaller than the threshold value, the wireless terminal 103 transmits, to the wireless terminal 102, a transmission-power-instruction signal which increases the transmission power.

The wireless terminal 102 receives the transmission-power-instruction signal, and increases or reduces the transmission power in accordance with the transmission-power-instruction signal in step S24.

The threshold value of the wireless terminal 103 is set to a value higher than or lower than an optimum received power by a predetermined value. The range of an increase or decrease in transmission power of the wireless terminal 102 is preferably smaller than or equal to the predetermined value. As a result, after adjustment of the transmission power of the wireless terminal 102, received power of the wireless terminal 103 can be caused to be close to the optimum received power without departing therefrom. The embodiment has effects analogous to those of the first embodiment.

### Third Embodiment

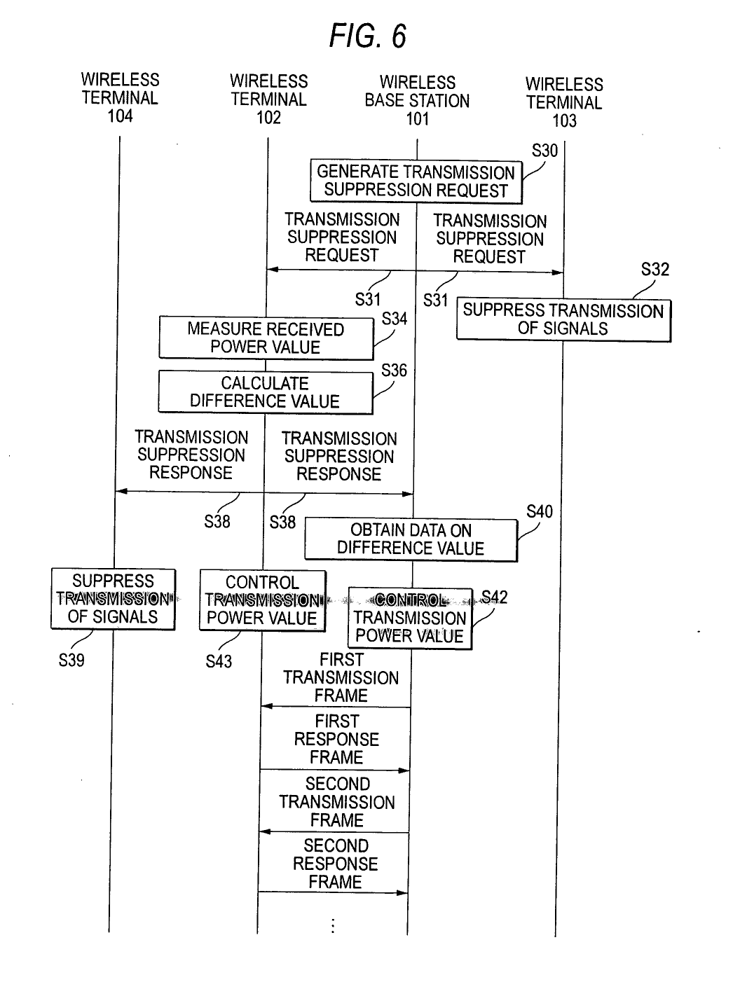

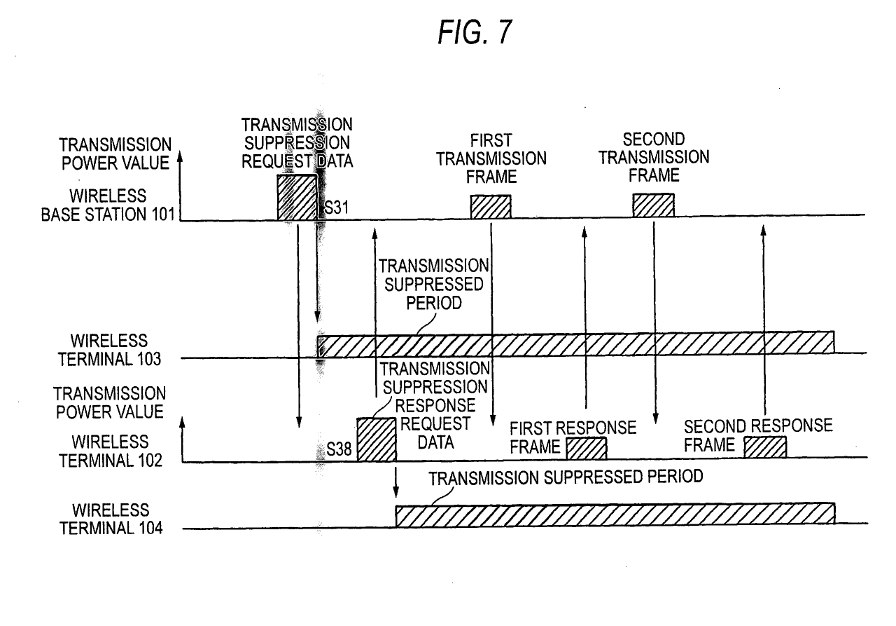

FIG. 6 is a flowchart showing operations of a wireless communication system of a third embodiment. FIG. 7 is a view showing operation timings of the third embodiment, and transmission power of the wireless base station 101, and those of the wireless terminals 102, 103, 104 respectively. Other configurations of the embodiment are analogous to those of the first embodiment shown in FIGS. 1 and 2, and their repeated descriptions are omitted. In the embodiment, the wireless base station 101 communicates with the wireless terminal 102 directly.

In this case, the wireless base station 101 of a certain BSS generates a transmission suppression request whose destination is the wireless terminal 102 (S30), and transmits the request (S30). The wireless base station 101 transmits the transmission suppression request with comparatively great transmission power so as to reach the wireless terminals 102, 103 in the BSS (see FIG. 7). The transmission suppression request is a signal for causing wireless terminals other than the destination terminal to suppress transmission of signals toward a wireless base station or the destination terminal. The transmission suppression request is called as an RTS (request to send) in IEEE 802.11.

Upon receipt of the transmission suppression request, the wireless terminal 103 suppresses transmission of signals toward the wireless base station 101 and the wireless terminal 102 for a predetermined communication-suppressed period (S32). The communication-suppressed period may be defined in other words as a Duration, or a priority period in which the wireless base station 101 and wireless terminal 102 communicate directly.

Upon receipt of the transmission suppression request, the measurement section 409 of the wireless terminal 102, which is the destination of the transmission suppression request, measures received power of the transmission suppression request (S34). The communication control section 401 of the wireless terminal 102 calculates a difference value between a reference value for received power which has been set in advance and the received power of the transmission suppression request (S36). The reference value of the received power is set to a received power value of a signal which can be received by the wireless terminal 102 or a received power value with which a certain receipt quality can be kept. The wireless terminal 102 transmits, to the wireless base station 101, a transmission suppression response (hereinafter simply called “a transmission suppression response”) in which data on the difference value is included (S38).

At this time, the wireless transmission section 102 transmits the transmission suppression response with comparatively great transmission power so as to reach the other wireless terminal 103 in the BSS and a wireless terminal 104 (unillustrated in FIG. 1) existing in the periphery of the wireless terminal 102 (see FIG. 7). The wireless terminal existing in the periphery of the wireless terminal 102 are, for instance, a hidden terminal existing at a location where a transmission suppression request from the wireless base station 101 cannot reach. The transmission suppression response is a response signal of acceptance for the transmission suppression request, and is a signal for causing a wireless terminal existing in the periphery of the wireless terminal 102 to suppress transmission of signals toward a wireless terminal 102. The transmission suppression response is called as a CTS (clear to send) in IEEE 802.11.

Upon receipt of the transmission suppression response, the wireless terminal 104 existing in the periphery of the wireless terminal 102 suppresses transmission of signals toward the wireless terminal 102 for a predetermined transmission-suppressed period (S39). By virtue of the above, the wireless base station 101 and the wireless terminal 102 can communicate with each other without being disturbed not only from the other wireless terminal 103 in the BSS but wireless terminals existing in the periphery of the wireless terminal 102.

Next, the wireless base station 101 receives the transmission suppression response, and obtains data on the difference value (S40). When the difference value is greater than or equal to the threshold value, the communication control 401 of the wireless base station 101 determines that the transmission power has a margin. In this case, the transmission power control section 408 controls the wireless transmission section 404 so as to lower the transmission power value. In contrast, when the difference value is smaller than the threshold value, the communication control 401 of the wireless base station 101 determines that the transmission power has no margin. In this case, the transmission power control section 408 controls the wireless transmission section 404 such that the transmission power value is increased or constant (S42).

When the difference value of the transmission suppression request is greater than or equal to the threshold value, the wireless terminal 102 determines that the transmission power has a margin. In this case, the transmission power control section 408 controls the wireless transmission section 404 so as to lower the transmission power value. In contrast, when the difference value is smaller than the threshold value, the communication control 401 of the wireless base station 101 determines that the transmission power has no margin. In this case, the transmission power control section 408 controls the wireless transmission section 404 such that the transmission power value is increased or constant (S43). Control of the transmission power value in the wireless terminal 102 is executed after transmission of the transmission suppression response (S38) and before transmission of the first response frame.

By virtue of the above, the wireless base station 101 and the wireless terminal 102 can transmit signals with appropriate electric power. Data associated with the electric power values of these signals may be communicated in accordance with IEEE 802.11h.

According to the embodiment, as shown in FIG. 7, the wireless base station 101 and the wireless terminal 102 transmit signals subsequent to the transmission suppression response with power comparatively small and barely enough to reach the wireless terminal 102 and the wireless base station 101 respectively. Therefore, the wireless terminal 102 and the wireless base station 101 can reduce excessive power consumption. In addition, the wireless terminal 102 and the wireless base station 101 can increase transmission power when the transmission power is too low. Consequently, the wireless terminal 102 and the wireless base station 101 can transmit signals with appropriate transmission power.

In the embodiment, as is in the first embodiment, the wireless terminal 102 calculates the difference value between the reference value for received power which has been set in advance and the received power of the transmission suppression request. However, as is in the second embodiment, the wireless terminal 102 may merely transmit a transmission-power-instruction signal—which instructs to increase or reduce transmission power—which is contained in the transmission suppression response. In this case, as described above, the threshold value of the wireless terminal 102 is set to a value higher than or lower than an optimum received power by a predetermined value. The increasing or reducing amount of the transmission power of the wireless base station 101 is preferably smaller than or equal to the predetermined value.

In the above embodiments, the transmission power for a signal immediately after transmission of the first transmission frame or that immediately after transmission of the transmission suppression response is increased or reduced. However, no particular limitation is imposed on a timing at which the transmission power is increased or reduced so long as after transmission of the first transmission frame or after transmission of the transmission suppression response.

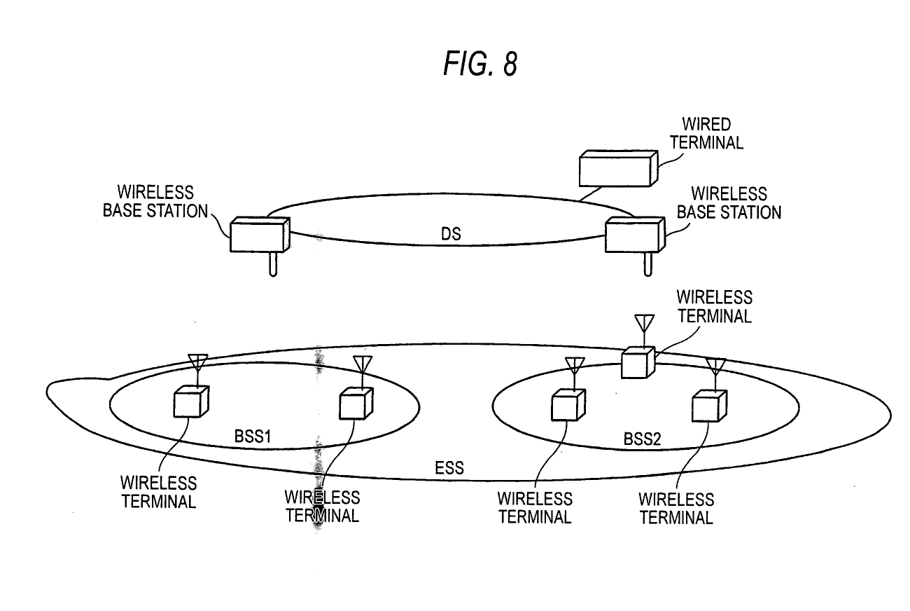

In the embodiments, the wireless base station and the wireless terminals are connected by wireless connection; however, they may be connected by means of a wired network. FIG. 1 illustrates a wireless LAN system constituted of a single BSS. However, as shown in FIG. 8, the wireless LAN system may be constituted of a plurality of BSSs. Such a constitution of a wireless LAN system is called as an ESS (extended service set) in IEEE 802.11. Wireless base stations 201 and 202, which are called a DS (distributed system) in IEEE 802.11, may be connected by means of either a wired network or wireless connection.

The invention is not limited to the above embodiments, and can be practiced while being modified in various manners without departing from the scope of the invention. In addition, by means of combining a plurality of elements disclosed in the present embodiments appropriately, a variety of inventions can be made. For example, some elements may be omitted from the elements described in the entire embodiments. Moreover, used in different embodiments may be combined appropriately.

1. A wireless communication system including a first communication apparatus, a second communication apparatus, and a third communication apparatus which are mutually communicable by wireless,
wherein the first communication apparatus comprises:
a first receiving section which receives a signal; and
a first transmission section which transmits, to both the second communication apparatus and the third communication apparatus, a first transmission signal whose destination is the second communication apparatus, and which transmits a second transmission signal whose destination is the second communication apparatus to the second communication apparatus with power enough to reach the second communication apparatus based on a response signal, from the second communication apparatus, which includes an information related to received power or receipt quality of the first transmission signal in the second communication apparatus,
the second communication apparatus comprises:
a second receiving section which receives the first transmission signal;
a measurement section which measures received power and receipt quality of the first transmission signal; and
a second transmission section which transmits the response signal to the first communication apparatus in accordance with the first transmission signal, and
the third communication apparatus comprises:
a third receiving section which receives the first transmission signal; and
a third transmission section which stops transmission of signals to the first communication apparatus and the second communication apparatus during a predetermined period after receipt of the first transmission signal.

2. The wireless communication system according to claim 1,
wherein the third communication apparatus is a wireless base station;
the first communication apparatus and the second communication apparatus are communication terminals which enables to perform indirect communication with each other through the third communication apparatus and which enables to perform direct communication with each other,
the first communication apparatus transmits the first transmission signal to the second communication apparatus and the third communication apparatus after switching from the indirect communication to the direct communication, and
the third communication apparatus provides the first communication apparatus and the second communication apparatus with priority time for the direct communication by the first transmission signal.

3. The wireless communication system according to claim 1,
wherein the second communication apparatus further comprises a comparative calculation section which compares the received power or receipt quality of the first transmission signal with a threshold value set in advance,
the second communication apparatus transmits, when the received power or receipt quality is larger than the threshold value, a transmission-power-instruction signal indicating that transmission power of the first transmission section is excessive to the first communication apparatus, and
the first communication apparatus reduces power of the second transmission signal in response to the transmission-power-instruction signal.

4. The wireless communication system according to claim 2,
wherein the second communication apparatus further comprises a comparative calculation section which compares the received power or receipt quality of the first transmission signal with a threshold value set in advance,
the second communication apparatus transmits, when the received power or receipt quality is larger than the threshold value, a transmission-power-instruction signal indicating that transmission power of the first transmission section is excessive to the first communication apparatus, and
the first communication apparatus reduces power of the second transmission signal in response to the transmission-power-instruction signal.

5. The wireless communication system according to claim 1,
wherein the second communication apparatus further comprises a comparative calculation section which calculates a difference value between the received power or receipt quality of the first transmission signal and a threshold value set in advance,
the second communication apparatus transmits the response signal including the difference value to the first communication apparatus, and
the first communication apparatus increases or reduces power of the second transmission signal based on the difference value.

6. The wireless communication system according to claim 2,
wherein the second communication apparatus further comprises a comparative calculation section which calculates a difference value between the received power or receipt quality of the first transmission signal and a threshold value set in advance,
the second communication apparatus transmits the response signal including the difference value to the first communication apparatus, and
the first communication apparatus increases or reduces power of the second transmission signal based on the difference value.

7. The wireless communication system according to claim 1,
wherein the receipt quality of the first transmission signal is any one of a frame error rate, a packet error rate, and a bit error rate of the first transmission signal.

8. The wireless communication system according to claim 2,
wherein the receipt quality of the first transmission signal is any one of a frame error rate, a packet error rate, and a bit error rate of the first transmission signal.

9. The wireless communication system according to claim 3,
wherein the receipt quality of the first transmission signal is any one of a frame error rate, a packet error rate, and a bit error rate of the first transmission signal.

10. The wireless communication system according to claim 1,
wherein the first communication apparatus is a wireless base station,
the second communication apparatus and the third communication apparatus are communication terminals which enables to communicate with each other through the first communication apparatus,
the first communication apparatus transmits, as the first transmission signal, a signal for stopping transmission from a communication apparatus other than the second communication apparatus being the destination of the first transmission signal to the first communication apparatus, and
the third communication apparatus stops transmission of signals to the first communication apparatus and the second communication apparatus during a predetermined period after receipt of the first transmission signal or the response signal.

11. A wireless communication method with use of a wireless communication system including a first communication apparatus, a second communication apparatus, and a third communication apparatus which are mutually communicable by wireless, comprising:
a step in which the first communication apparatus transmits a first transmission signal whose destination is the second communication apparatus with power enough to reach both the second communication apparatus and the third communication apparatus;
a step in which the second communication apparatus receives the first transmission signal, and measures received power or receipt quality of the first transmission signal;
a step in which the second communication apparatus transmits a response signal in response to the first transmission signal to the first communication apparatus; and
a step in which the third communication apparatus stops transmission of signals to the first communication apparatus and the second communication apparatus during a predetermined period after receipt of the first transmission signal.

12. The wireless communication method according to claim 11,
wherein the third communication apparatus is a wireless base station;
the first communication apparatus and the second communication apparatus are communication terminals which enables to perform indirect communication with each other through the third communication apparatus and which enables to perform direct communication with each other,
the first communication apparatus transmits the first transmission signal to the second communication apparatus and the third communication apparatus after switching from the indirect communication to the direct communication, and
the third communication apparatus provides the first communication apparatus and the second communication apparatus with priority time for the direct communication by the first transmission signal.

13. The wireless communication method according to claim 11,
wherein the second communication apparatus further comprises a comparative calculation section which compares the received power or receipt quality of the first transmission signal with a threshold value set in advance,
the second communication apparatus transmits, when the received power or receipt quality is larger than the threshold value, a transmission-power-instruction signal indicating that transmission power of the first transmission section is excessive to the first communication apparatus, and
the first communication apparatus reduces power of the second transmission signal in response to the transmission-power-instruction signal.

14. The wireless communication method according to claim 12,
wherein the second communication apparatus further comprises a comparative calculation section which compares the received power or receipt quality of the first transmission signal with a threshold value set in advance,
the second communication apparatus transmits, when the received power or receipt quality is larger than the threshold value, a transmission-power-instruction signal indicating that transmission power of the first transmission section is excessive to the first communication apparatus, and
the first communication apparatus reduces power of the second transmission signal in response to the transmission-power-instruction signal.

15. The wireless communication method according to claim 11,
wherein the second communication apparatus further comprises a comparative calculation section which calculates a difference value between the received power or receipt quality of the first transmission signal and a threshold value set in advance,
the second communication apparatus transmits the response signal including the difference value to the first communication apparatus, and
the first communication apparatus increases or reduces power of the second transmission signal based on the difference value.

16. The wireless communication method according to claim 12,
wherein the second communication apparatus further comprises a comparative calculation section which calculates a difference value between the received power or receipt quality of the first transmission signal and a threshold value set in advance,
the second communication apparatus transmits the response signal including the difference value to the first communication apparatus, and
the first communication apparatus increases or reduces power of the second transmission signal based on the difference value.

17. The wireless communication method according to claim 11,
wherein the receipt quality of the first transmission signal is any one of a frame error rate, a packet error rate, and a bit error rate of the first transmission signal.

18. The wireless communication method according to claim 12,
wherein the receipt quality of the first transmission signal is any one of a frame error rate, a packet error rate, and a bit error rate of the first transmission signal.

19. The wireless communication method according to claim 13,
wherein the receipt quality of the first transmission signal is any one of a frame error rate, a packet error rate, and a bit error rate of the first transmission signal.

20. The wireless communication method according to claim 11,
wherein the first communication apparatus is a wireless base station,
the second communication apparatus and the third communication apparatus are communication terminals which enables to communicate with each other through the first communication apparatus,
the first communication apparatus transmits, as the first transmission signal, a signal for stopping transmission from a communication apparatus other than the second communication apparatus being the destination of the first transmission signal to the first communication apparatus, and
the third communication apparatus stops transmission of signals to the first communication apparatus and the second communication apparatus during a predetermined period after receipt of the first transmission signal or the response signal.
